(19) United States
(12) Patent Application Publication
(10) Pub. No.: US 2008/0297893 A1
(43) Pub. Date: Dec. 4, 2008

(54) Pressure sensitive positioning projection screen

(75) Inventor: Chun-Wang Sun, Taipei (TW)

Correspondence Address: Haverstock And Owens LLP, 162 North Wolfe Road, Sunnyvale, CA, 94086, US

(73) Assignee: National Taiwan University

(21) Appl. No.: 11/809,284

(22) Filed: May 30, 2007

(51) Int. Cl. G03B 21/60

(52) U.S. Cl. 359/443

(57) ABSTRACT

A pressure sensitive positioning projection screen is provided for displaying a first projected image and providing a coordinate signal of a pressed position. The pressure sensitive positioning projection screen comprises a screen body having a first and a second insulation layers, a plurality of mutually separated and isolated first electrodes arranged along a first direction and configured in the first insulating layer, and a plurality of mutually separated and isolated second electrodes arranged along a second direction and configured in the second insulating layer, wherein the first electrodes are interlaced with the second electrodes for providing the coordinate signal of the pressed position along the first and the second directions.

### FIELD OF THE INVENTION

The present invention relates to a projection screen. More particularly, the present invention relates to a pressure sensitive positioning projection screen.

### BACKGROUND OF THE INVENTION

So far, the electric game is a very popular kind of recreation. The interactions with the players have been transformed from receiving keyboard operations into receiving the motions of the players. Take an electric game of throwing a ball to a vase for example, if a player throw a virtual ball to a vase projected on a wall or on a projection screen in front of the wall, then the game console will correspondingly project a screen of the vase which is broken into pieces by detecting the position of the wall or the projection screen pressed by the virtual ball. Such interaction between the electric game and its user could substantially increase the amusement.

As shown in FIG. 1, the conventional interactive electric game includes a wall or a projection screen 1 and a positioning camera device for detecting the pressed position on the wall or the projection screen 1. The positioning camera device includes a first camera 2, a second camera 3, and an image processing circuit (not shown in FIG. 1), wherein the first camera 2 captures an image along a direction parallel to the projection screen 1 and the second camera 3 captures the image along another direction perpendicular to the projection screen 1. The image captured by the first camera 2 and the second camera 3 is transmitted to the image processing circuit for image recognition and processing so as to generate a coordinate of the pressed position on the wall or the projection screen by the virtual ball. Then the coordinate of the pressed position is transmitted to the game console by the image processing circuit for changing the screen displayed on the wall or the projection screen 1. However, because the calculation about the image process spends a lot of time and the amount of the cameras or the image processing circuits needs to be increased, the cost of the interactive electric game is higher. Furthermore, the first camera 2 and the second camera 3 may need to be calibrated frequently because of crash or other factors during the game. Besides, the image quality affected by the light intensity of the light source in the actual operating environment and the visual angle affected by the arranged position of the cameras both will affect the accuracy of detecting the pressed position. Therefore, the coordinate of the pressed position obtained from the prior art in FIG. 1 is inaccurate.

Therefore, because of the defect in the prior art, the inventors provide a pressure sensitive positioning projection screen to effectively overcome the demerits in the prior art.

### SUMMARY OF THE INVENTION

In accordance with an aspect of the present invention, a pressure sensitive positioning projection screen for displaying a projected image and providing a coordinate signal of a position to be pressed is provided. The pressure sensitive positioning projection screen comprises an insulating substrate, n first electrodes, m second electrodes and a detecting circuit. The n first electrodes are configured along a first direction in a first plane of the insulating substrate and mutually separated and isolated. Each one of the n first electrodes comprises two mutually isolated conductive strips being configured parallel and opposite to each other. The m second electrodes configured along a second direction in a second plane of the insulating substrate and mutually separated and isolated. Each one of the m second electrodes comprises two mutually isolated conductive strips being configured parallel and opposite to each other. The detecting circuit is electrically connected to each of the mutually isolated conductive strips of the n first and the m second electrodes for forming n+m loops respectively. The n first electrodes are isolated from the m second electrodes. When the position is pressed to contact with each other the two mutually isolated conductive strips of i^{th} (1≦i≦n) first electrode and with each other the two mutually isolated conductive strips of j^{th} (1≦j≦m) second electrode to respectively generate a first electrical signal and a second electrical signal which are detected by one of the n+m loops corresponding to the i^{th} first electrode and the other one of the n+m loops corresponding to the j^{th} first electrode respectively. The detecting circuit provides the coordinate signal (i, j) of the pressed position for the first and the second directions respectively, so as to display the projected image on a surface of the insulating substrate when the position is pressed.

Preferably, the insulating substrate is made of one of a soft and an elastic materials for allowing the insulating substrate to be rolled up.

Preferably, when the position is no longer pressed by a force, the two mutually isolated conductive strips of i^{th} first electrode contact no more and the two mutually isolated conductive strips of j^{th} second electrode contact no more respectively are disappeared by a resilience of the one of the soft and the elastic materials, and the first electrical signal and the second electrical signal are no more detectible by the corresponding ones of the n+m loops.

Preferably, the insulation substrate comprises a first and a second insulation layers opposing to each other for respectively configuring therein the two mutually isolated conductive strips of the n first electrodes, and further comprises a third and a fourth insulation layers opposing to each other for respectively configuring therein the two mutually isolated conductive strips of the m second electrodes, where the first, the second, the third and the fourth insulation layers are arranged in sequence.

Preferably, the first direction is perpendicular to the second direction.

Preferably, the first direction is a width direction of the pressure sensitive positioning projection screen and the second direction is a length direction of the pressure sensitive positioning projection screen.

Preferably, the detecting circuit provides a start and a stop times of a pressing according to a respective duration of the first and the second electrical signals.

Preferably, one of the first and the second electrical signals is one selected from a group consisting of a resistance variation signal, a voltage variation signal, and a current variation signal.

In accordance with another aspect of the present invention, a pressure sensitive positioning projection screen for displaying a first projected image and providing a coordinate signal of a pressed position is provided. The pressure sensitive positioning projection screen comprises a screen body having a first and a second insulation layers, a plurality of mutually separated and isolated first electrodes arranged along a first direction and configured in the first insulating layer, and a plurality of mutually separated and isolated second electrodes arranged along a second direction and configured in the second insulating layer. The first electrodes are interlaced with the second electrodes for providing the coordinate signal of the pressed position along the first and the second directions.

Preferably, the screen body is made of one of a soft and an elastic materials for allowing the screen body being rolled up.

Preferably, the first electrodes and the second electrodes are elongate.

Preferably, the pressure sensitive positioning projection screen further comprises a detecting circuit electrically connected to the first and the second electrodes for detecting and transmitting the coordinate signal for allowing a second projected image corresponding to the coordinate signal to be displayed on the projection screen.

Preferably, the first direction is perpendicular to the second direction.

Preferably, the coordinate signal comprises a first electrical signal and a second electrical signal respectively generated by one of the first electrodes and one of the second electrodes corresponding to the pressed position.

Preferably, one of the first and the second electrical signals is one selected from a group consisting of a resistance variation signal, a voltage variation signal, and a current variation signal.

In accordance with a further aspect of the present invention, a pressure sensitive positioning projection screen for providing a coordinate signal of a pressed position is provided. The pressure sensitive positioning projection screen comprises an insulating body having a resilience and an electrode device configured in the insulating body. The electrode device is arranged to provide the coordinate signal corresponding to a transformation of the insulation body by using the resilience.

Preferably, the insulating body is made of one of a soft and elastic materials for being rolled up thereby.

Preferably, the pressure sensitive positioning projection screen further comprises a detecting circuit for providing the coordinate signal to a control device for displaying the projected image when the pressed position is pressed, wherein the insulation body comprises a first and a second layers, and the electrode device comprises a plurality of mutually separated and isolated first electrodes arranged along a first direction and configured in the first insulating layer and a plurality of mutually separated and isolated second electrodes arranged along a second direction and configured in the second insulating layer.

Preferably, the first direction is perpendicular to the second direction.

Preferably, the coordinate signal comprises a first electrical signal and a second electrical signal being respectively generated by respective ones of the first electrodes and the second electrodes corresponding to the pressed position, and one of the first and the second electrical signal is selected from a group consisting of a resistance variation signal, a voltage variation signal, and a current variation signal.

### BRIEF DESCRIPTION OF THE DRAWINGS

FIG. 1 is a diagram showing the arrangement of the positioning cameras of the interactive electric game according to the prior art; and

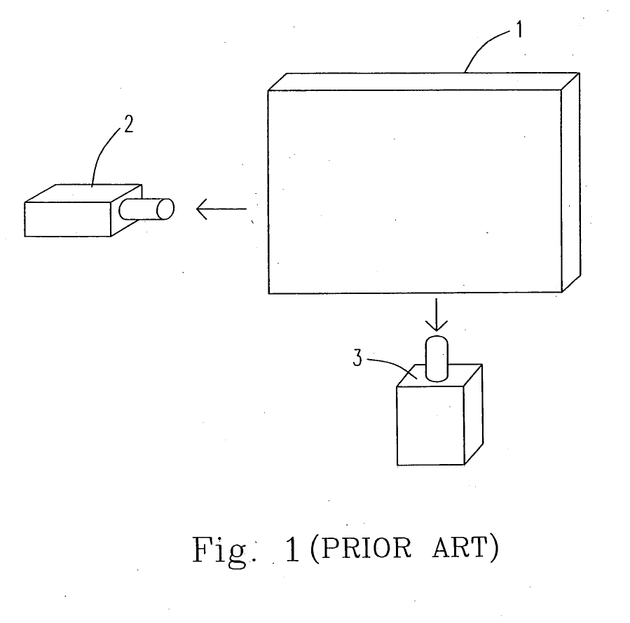

FIG. 2 is a diagram showing the structure of a pressure sensitive positioning projection screen according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

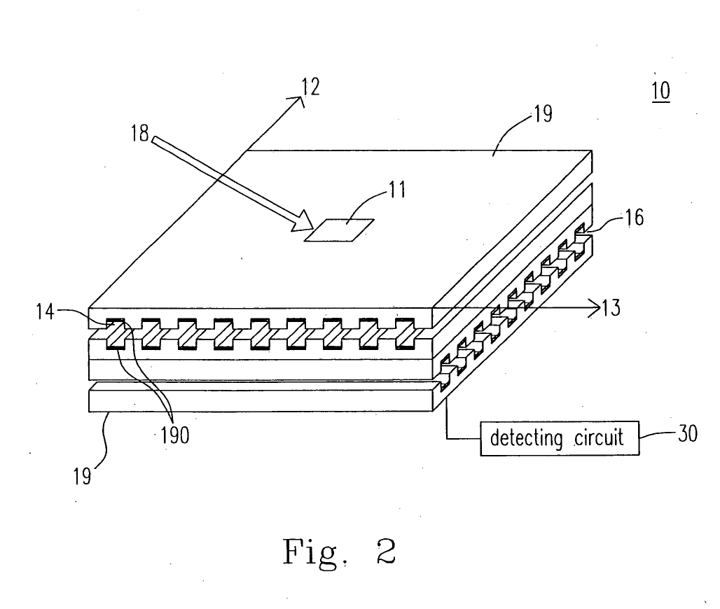

Please refer to FIG. 2, which is a diagram showing a pressure sensitive positioning projection screen according to a preferred embodiment of the present invention. As shown, the pressure sensitive positioning projection screen 10 provides a coordinate signal of a pressed position 11 and displays an image projected by a game console simultaneously. The pressure sensitive positioning projection screen 10 is configured in front of a hard plane (the hard plane is under the pressure sensitive positioning projection screen 10 in FIG. 2). The pressed position 11 caused by a force 18 is in front of the pressure sensitive positioning projection screen 10 (the pressed position 11 is on the pressure sensitive positioning projection screen 10 in FIG. 2).

The pressure sensitive positioning projection screen 10 comprises n (n>1) first electrodes 14 configured along a first direction 13 and mutually separated and isolated and m (m>1) second electrodes 16 configured along a second direction 12 and mutually separated and isolated. The first electrodes 14 and the second electrodes 16 are elongate and respectively configured in different planes. Each one of the n first electrodes 14 comprises two mutually isolated conductive strips 190 being configured parallel and opposite to each other, and each one of the m second electrodes 16 comprises two mutually isolated conductive strips 190 being configured parallel and opposite to each other. The insulating substrate 19 is made of a soft, flat and elastic material for allowing the insulating substrate 19 to be rolled up for storage and convenient usage of the pressure sensitive positioning projection screen 10. As shown in FIG. 2, the embodiment comprises four insulating layers of the insulating substrate 19, wherein the outer (or upper) two insulating layers have the conductive strips 190 of the first electrodes 14 respectively embedded therein, and the inner (or lower) two insulating layers have the conductive strips 190 of the second electrodes 16 respectively embedded therein. It is to be noticed that the conductive strips 190 are configured in the insulating layers at a proper distance, so the insulation layers in FIG. 2 could be closed to each other and the opposite conductive strips 190 embedded therein will not contact each other.

When the force 18 strikes the pressed position 11, because of the soft material of the insulation substrate 19 and the resistance of the hard plane (such as a wall), two conductive strips 190 of a specific second electrode 16 (suppose it is the j^{th} second electrode 16, 1≦j≦m) corresponding to the pressed position 11 will contact with each other. When the pressed position 11 is no longer pressed by the force 18, the two mutually isolated conductive strips 190 of the j^{th} second electrode 16 will back to the separate state because of the resilience of the insulating substrate 19. Similarly, when the force 18 strikes the pressed position 11, two conductive strips 190 of a specific first electrode 14 (suppose it is the i^{th} first electrode 14, 1≦i≦n) corresponding to the pressed position 11 will contact with each other. When the pressed position 11 is no longer pressed by the force 18, the two conductive strips 190 of the i^{th} first electrode 14 will back to the separate state because of the resilience of the insulating substrate 19.

Individual loops (n+m loops) are built up via respective electrical connections between a detecting circuit 30 and each of the mutually isolated conductive strips 190 of the n first electrodes 14 and the m second electrodes 16. When the state of one conductive strip pair 190 changes from separation (open) to contact (short) caused by the strike of the force 18, and then changes to separation (open) caused by the disappearance of the force 18, the detecting circuit 30 could correspondingly detect the variations of the resistance or the voltage or the current of the loop of the conductive strip pair 190. The above electrical variations detected in any one of the first electrodes 14 is called a first electrical signal hereinafter, while those detected in any one of the second electrodes 16 is called a second electrical signal hereinafter. Whether the first and the second electrical signals are variations of the resistance or the voltage or the current or other electrical signals is depended on the detecting circuit 30. Regarding the details of the detecting circuit 30, they should be well known by the skilled person in this field, which are not described in detail here.

When the force 18 strikes the pressed position 11, which is in a proper scope crossed by the i^{th} first electrode 14 and the j^{th} second electrode 16, the contact of the two conductive strips 190 of the i^{th} first electrode 14 and the contact of the two conductive strips 190 of the j^{th} second electrode 16 respectively cause the generation of the first electrical signals and the second electrical signals. The first electrical signals provide position information (i) of the pressed position 11 along the first direction 13, and the second electrical signals provide position information (j) of the pressed position 11 along the second direction 12. Therefore, the detecting circuit 30 of the pressure sensitive positioning projection screen 10 provides the coordinate signal (i, j) of the pressed position 11 along the first and the second directions according to the first and the second electrical signals.

Furthermore, besides providing the coordinate signal, the detecting circuit 30 also provides a start and a stop times of a pressing according to a respective duration of the first and the second electrical signals. The information is provided to the game console for generating the corresponding projected image by the game console and displaying the image on a surface of the insulating substrate. The electrical variations are caused by the contact of two conductive stripes 190. According to the actual necessity for the application of the pressure sensitive positioning projection screen 10, the designs of the first electrodes 14 and the second electrodes 16 can be different, which make the first and the second electrical signals respectively have different one of the current variation signal, the voltage variation signal and the resistance variation signal for accurately obtaining the coordinate signal of the pressed position 11. The information changes the images projected on the pressure sensitive positioning projection screen 10 and the different images make the interactive visual effects thereby.

Besides, the first direction 13 and the second direction 12 are preferably perpendicular to each other or respectively parallel to the width and the length directions of the pressure sensitive positioning projection screen 10 for further simplifying the signal calculating process of the coordinate signal generated by the first and the second electrical signals.

Based on the above, the present invention indeed provides a pressure sensitive positioning projection screen, which provides a coordinate signal of a pressed position by using a plurality of first electrodes configured along a first direction and a plurality of second electrodes configured along a second direction. The present invention breaks the limitations in the prior arts, which could not accurately provide a coordinate signal of a pressed position on the projection screen by a positioning camera device, and develops a pressure sensitive positioning projection screen assembling a plurality of first electrodes and a plurality of second electrodes. Hence, the present invention has simple technology, low production costs and high industrial applicability.

While the invention has been described in terms of what is presently considered to be the most practical and preferred embodiments, it is to be understood that the invention needs not be limited to the disclose embodiments. Therefore, it is intended to cover various modifications and similar arrangements included within the spirit and scope of the appended claims, which are to be accorded with the broadest interpretation so as to encompass all such modifications and similar structures.

What is claimed is:

1. A pressure sensitive positioning projection screen for displaying a projected image and providing a coordinate signal of a position to be pressed, comprising:
an insulating substrate;
n first electrodes configured along a first direction in a first plane of the insulating substrate and mutually separated and isolated, wherein each one of the n first electrodes comprises two mutually isolated conductive strips being configured parallel and opposite to each other;
m second electrodes configured along a second direction in a second plane of the insulating substrate and mutually separated and isolated, wherein each one of the m second electrodes comprises two mutually isolated conductive strips being configured parallel and opposite to each other; and
a detecting circuit electrically connected to each of the mutually isolated conductive strips of the n first and the m second electrodes for forming n+m loops respectively, wherein:
the n first electrodes are isolated from the m second electrodes;
when the position is pressed to contact with each other the two mutually isolated conductive strips of i^{th} (1≦i≦n) first electrode and with each other the two mutually isolated conductive strips of j^{th} (1≦j≦m) second electrode to respectively generate a first electrical signal and a second electrical signal which are detected by one of the n+m loops corresponding to the i^{th} first electrode and the other one of the n+m loops corresponding to the j^{th} first electrode respectively; and
the detecting circuit provides the coordinate signal (i, j) of the pressed position for the first and the second directions respectively, so as to display the projected image on a surface of the insulating substrate when the position is pressed.

2. A pressure sensitive positioning projection screen as claimed in claim 1, wherein the insulating substrate is made of one of a soft and an elastic materials for allowing the insulating substrate to be rolled up.

3. A pressure sensitive positioning projection screen as claimed in claim 2, wherein when the position is no longer pressed by a force, the two mutually isolated conductive strips of i^{th} first electrode contact no more and the two mutually isolated conductive strips of j^{th} second electrode contact no more respectively are disappeared by a resilience of the one of the soft and the elastic materials, and the first electrical signal and the second electrical signal are no more detectible by the corresponding ones of the n+m loops.

4. A pressure sensitive positioning projection screen as claimed in claim 1, wherein the insulation substrate comprises a first and a second insulation layers opposing to each other for respectively configuring therein the two mutually isolated conductive strips of the n first electrodes, and further comprises a third and a fourth insulation layers opposing to each other for respectively configuring therein the two mutually isolated conductive strips of the m second electrodes, where the first, the second, the third and the fourth insulation layers are arranged in sequence.

5. A pressure sensitive positioning projection screen as claimed in claim 1, wherein the first direction is perpendicular to the second direction.

6. A pressure sensitive positioning projection screen as claimed in claim 1, wherein the first direction is a width direction of the pressure sensitive positioning projection screen and the second direction is a length direction of the pressure sensitive positioning projection screen.

7. A pressure sensitive positioning projection screen as claimed in claim 1, wherein the detecting circuit provides a start and a stop times of a pressing according to a respective duration of the first and the second electrical signals.

8. A pressure sensitive positioning projection screen as claimed in claim 1, wherein one of the first and the second electrical signals is one selected from a group consisting of a resistance variation signal, a voltage variation signal, and a current variation signal.

9. A pressure sensitive positioning projection screen for displaying a first projected image and providing a coordinate signal of a pressed position, comprising:
a screen body having a first and a second insulation layers;
a plurality of mutually separated and isolated first electrodes arranged along a first direction and configured in the first insulating layer; and
a plurality of mutually separated and isolated second electrodes arranged along a second direction and configured in the second insulating layer,
wherein the first electrodes are interlaced with the second electrodes for providing the coordinate signal of the pressed position along the first and the second directions.

10. A pressure sensitive positioning projection screen as claimed in claim 9, wherein the screen body is made of one of a soft and an elastic materials for allowing the screen body being rolled up.

11. A pressure sensitive positioning projection screen as claimed in claim 9, wherein the first electrodes and the second electrodes are elongate.

12. A pressure sensitive positioning projection screen as claimed in claim 9, further comprising a detecting circuit electrically connected to the first and the second electrodes for detecting and transmitting the coordinate signal for allowing a second projected image corresponding to the coordinate signal to be displayed on the projection screen.

13. A pressure sensitive positioning projection screen as claimed in claim 9, wherein the first direction is perpendicular to the second direction.

14. A pressure sensitive positioning projection screen as claimed in claim 9, wherein the coordinate signal comprises a first electrical signal and a second electrical signal respectively generated by one of the first electrodes and one of the second electrodes corresponding to the pressed position.

15. A pressure sensitive positioning projection screen as claimed in claim 14, wherein one of the first and the second electrical signals is one selected from a group consisting of a resistance variation signal, a voltage variation signal, and a current variation signal.

16. A pressure sensitive positioning projection screen for providing a coordinate signal of a pressed position, comprising:
an insulating body having a resilience; and
an electrode device configured in the insulating body, and arranged to provide the coordinate signal corresponding to a transformation of the insulation body by using the resilience.

17. A pressure sensitive positioning projection screen as claimed in claim 16, wherein the insulating body is made of one of a soft and elastic materials for being rolled up thereby.

18. A pressure sensitive positioning projection screen as claimed in claim 16, further comprising:
a detecting circuit for providing the coordinate signal to a control device for displaying the projected image when the pressed position is pressed, wherein the insulation body comprises a first and a second layers, and the electrode device comprises a plurality of mutually separated and isolated first electrodes arranged along a first direction and configured in the first insulating layer and a plurality of mutually separated and isolated second electrodes arranged along a second direction and configured in the second insulating layer.

19. A pressure sensitive positioning projection screen as claimed in claim 18, wherein the first direction is perpendicular to the second direction.

20. A pressure sensitive positioning projection screen as claimed in claim 18, wherein the coordinate signal comprises a first electrical signal and a second electrical signal being respectively generated by respective ones of the first electrodes and the second electrodes corresponding to the pressed position, and one of the first and the second electrical signal is selected from a group consisting of a resistance variation signal, a voltage variation signal, and a current variation signal.
